(19) United States
(12) Patent Application Publication
(10) Pub. No.: US 2016/0187912 A1
(43) Pub. Date: Jun. 30, 2016

(54) CURRENT GENERATOR AND METHOD

(71) Applicant: Samsung Electro-Mechanics Co., Ltd., Suwon-Si (KR)

(72) Inventor: Soo Woong LEE, Suwon-Si (KR)

(73) Assignee: Samsung Electro-Mechanics Co., Ltd., Suwon-Si (KR)

(21) Appl. No.: 14/959,605

(22) Filed: Dec. 4, 2015

(30) Foreign Application Priority Data
Dec. 26, 2014 (KR) 10-2014-0190661

(51) Int. Cl. G05F 3/08

(52) U.S. Cl. CPC G05F 3/08

(57) ABSTRACT

A current generator may include a reference current generator configured to respectively generate a first reference current and a second reference current, a driving current generator configured to generate a driving current from the first reference current and the second reference current, and a compensator configured to respectively control the reference current generator generating of the first reference current and/or the second reference current based on a determination of whether the driving current changes. Current, and a clock signal based on the current, may be stably generated under an environment in which the temperatures change.

### CROSS-REFERENCE TO RELATED APPLICATION

This application claims the priority and benefit of Korean Patent Application No. 10-2014-0190661, filed on Dec. 26, 2014 with the Korean Intellectual Property Office, the disclosure of which is incorporated herein by reference.

### BACKGROUND

1. Field

One or more embodiments of the present disclosure relate to a current generator and method.

2. Description of Related Art

When typical a current generator is not affected by a surrounding environment or considered independent of the surrounding environment, such a current generator may be considered as outputting a stable current. However, an unstable output may result from devices using current that changes in response to temperature. Therefore there may be a desire for providing stable output current against such changes in environment or environmental conditions for current generating technologies.

As another particular example, when an internal clock signal is generated using a current source, and current of the current source is unstable, the internal clock signal is also unstable, which may result in the overall system of an electronic device(s) using the current source and clock signal becoming unstable.

### SUMMARY

One or more embodiments provide a current generator, including a reference current generator configured to respectively generate a first reference current and a second reference current, a driving current generator configured to generate a driving current from the first reference current and the second reference current, and a compensator configured to respectively control the reference current generator generating of the first reference current and/or the second reference current based on a determination of whether the driving current changes.

The first reference current may increase in proportion to changes in temperature and the second reference current may increase in inverse proportion to changes in temperature.

The compensator may control the reference current generator to increase or decrease current levels of any one of the first reference current and the second reference current to compensate for a change in the driving current.

The reference current generator may include a first reference current generator configured to generate the first reference current so as to change in proportion to changes in temperature, and a second reference current generator configured to generate the second reference current so as to change in inverse proportion to changes in temperature.

The compensator may control the first reference current generator to decrease a current level of the first reference current when the determination indicates that the driving current is increased.

The compensator may control the second reference current generator to increase a current level of the second reference current when the determination indicates that the driving current is increased.

The compensator may control the first reference current generator to increase a current level of the first reference current when the determination indicates that the driving current is decreased.

The compensator may control the second reference current generator to decrease a current level of the second reference current when the determination indicates that the driving current is decreased.

The first reference current generator may include an output switch, a plurality of resistors having respective first terminals connected to the output switch, and a plurality of current switches having respective first terminals that are connected to respective second terminals of the plurality of resistors, and having respective second terminals that are grounded, wherein the compensator may control a switching operation of the plurality of current switches to control the first reference current generator.

The compensator may include a hysteresis comparator receiving a driving voltage corresponding to the driving current, a first comparison voltage, and a second comparison voltage, and the compensator may output a control signal to the reference current generator when the driving voltage is determined to exceed the first comparison voltage or when the driving voltage is determined to be less than the second comparison voltage.

The current generator may include an oscillator generating a clock signal, driven by the driving current, wherein the generating of the clock signal may be based on an output of the compensator corresponding to the respective control the reference current generator based on the determination of whether the driving current changes.

One or more embodiments provide a current generator, including a current generator configured to generate a driving current from respectively generated first and second reference currents and to control the generating of the first reference current and/or the second reference current based on a determination of whether the driving current changes, and an oscillator generating a clock signal using the driving current.

The current generator may include a reference current generator configured to respectively generate the first reference current and the second reference current, a driving current generator configured to generate the driving current from the first reference current and the second reference current, and a compensator controlling the reference current generator based on a determination of whether the driving current changes.

The first reference current may increase in proportion to changes in temperature, the second reference current may increase in inverse proportion to changes in temperature, and the compensator may control the reference current generator to increase or decrease current levels of any one of the first reference current and the second reference current to compensate for a change in the driving current.

The reference current generator may include a first reference current generator configured to generate the first reference current so as to change in proportion to changes in temperature, and a second reference current generator configured to generate the second reference current so as to change in inverse proportion to changes in temperature.

The compensator may control the first reference current generator to decrease a current level of the first reference current when the determination indicates that the driving current is increased, or control the second reference current generator to increase a current level of the second reference current when the determination indicates that the driving current is increased.

The compensator may control the first reference current generator to increase a current level of the first reference current when the determination indicates that the driving current is decreased, or control the second reference current generator to decrease a current level of the second reference current when the determination indicates that the driving current is decreased.

One or more embodiments provide a current generating method, the method including generating a first reference current whose current level increases when a temperature increases, generating a second reference current whose current level decreases when the temperature increases, generating a driving current from the generated first reference current and the generated second reference current, determining whether the generated driving current changes, and controlling, based on the determining, at least one of the generating of the first reference current so as to adjust a current level of the first reference current and the generating of the second reference current so as to adjust a current level of the second reference current, to compensate for determined changes in the generated driving current.

The method may further include generating a clock signal, driven by the driving current, wherein the generating of the clock signal includes controlling a frequency of clock signal based on the controlling of the at least one of the generating of the first reference current and the generating of the second reference current to adjust any of the current levels of the first and second reference currents.

Other features and/or aspects will be apparent from the following detailed description, the drawings, and the claims.

### BRIEF DESCRIPTION OF DRAWINGS

The above and/or other aspects, features and/or advantages of the present disclosure will be more clearly understood from the following detailed description taken in conjunction with the accompanying drawings, in which:

FIG. 1 is a diagram illustrating a current generator, according to one or more embodiments;

FIG. 2 is a diagram illustrating temperature characteristics of current output from a reference current generator, according to one or more embodiments;

FIG. 3 is a diagram illustrating a current generator, according to one or more embodiments;

FIG. 4 is a diagram illustrating a first reference current generator, according to one or more embodiments;

FIG. 5 is a diagram illustrating a second reference current generator, according to one or more embodiments;

FIG. 6 is a diagram illustrating a compensator, according to one or more embodiments;

FIG. 7 is a diagram illustrating example considerations and output of a compensator in response to changes in temperature, according to one or more embodiments;

FIG. 8 is a diagram illustrating a clock signal generating system, according to one or more embodiments; and

FIG. 9 is a diagram illustrating a current generator, according to one or more embodiments.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that may be well known to one of ordinary skill in the art may be omitted for increased clarity and conciseness.

The features described herein may be embodied in different forms, and are not to be construed as being limited to the examples described herein.

Various alterations and modifications may be made to the described embodiments, some of which will be illustrated in detail in the drawings and detailed description. However, it should be understood that these embodiments are not construed as limited to the illustrated forms and include all changes, equivalents, or alternatives within the idea and the technical scope of this disclosure.

Terms used herein are to merely explain specific embodiments, and thus are not meant to be limiting. A singular expression includes a plural expression except when two expressions are contextually different from each other. For example, as used herein, the singular forms “a,” “an” and “the” are intended to include the plural forms as well, unless the context clearly indicates otherwise. The use of any and all examples, or exemplary language (e.g., “such as”) provided herein, is intended merely to better illuminate the underlying concept and does not pose a limitation on the scope of the disclosure. Herein, the terms “include” or “have” are also intended to indicate that characteristics, figures, operations, components, or elements disclosed on the specification or combinations thereof exist. The term “include” or “have” should be understood so as not to pre-exclude the existence of one or more other characteristics, figures, operations, components, elements or combinations thereof or additional possibilities. In addition, terms including ordinal numbers such as ‘first’, ‘second’, etc., are used for convenience of description to describe or differentiate between various elements but the elements should not be defined by these terms, and unless contextually having a different meaning are not intended to represent a required sequence or ordering.

Unless otherwise defined, all terms including technical and scientific terms used herein have the same meaning as commonly understood by one of ordinary skill in the art to which this invention belongs, in view of the present disclosure. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Hereinafter, certain embodiments will be explained in more detail with reference to the attached drawings, wherein like reference numerals refer to like elements throughout. Like or the same component or components corresponding to each other will be provided with the same reference numeral, and their detailed explanation will be omitted. When it is determined that a detailed description of a related or known function or configuration may make a purpose of an embodiment of the present disclosure unnecessarily ambiguous or verbose, such a detailed description may be omitted.

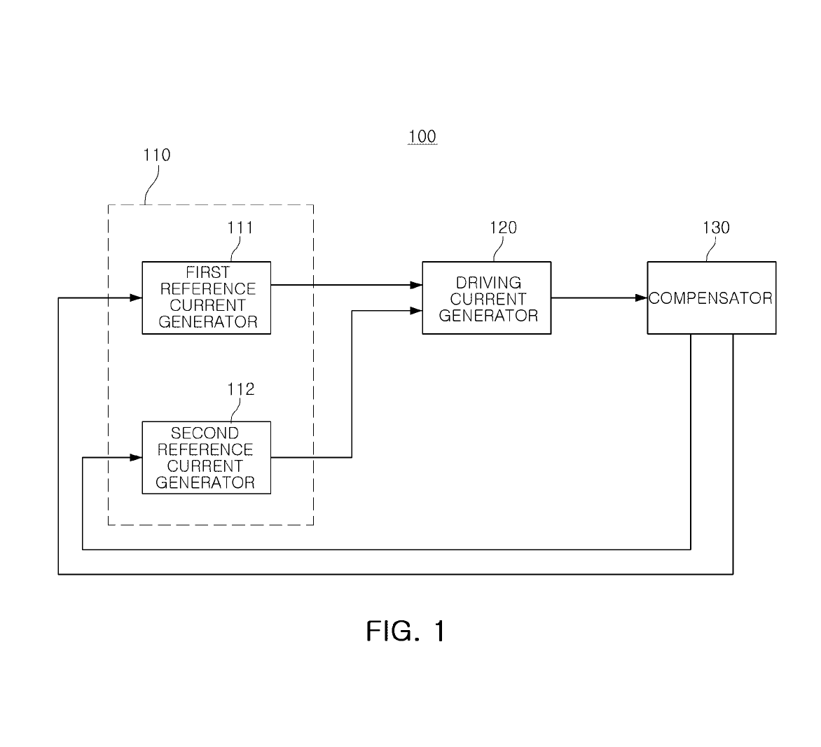

FIG. 1 is a diagram illustrating a current generator, according to one or more embodiments.

Referring to FIG. 1, a current generator 100 may include a reference current generator 110, a driving current generator 120, and a compensator 130, for example.

The reference current generator 110 may include a first reference current generator 111 and a second reference current generator 112, for example.

Accordingly, in this example, reference current generator 110 may generate two reference currents, for instance, a first reference current by the first reference current generator 111 and a second reference current by the second reference current generator 112. The first reference current and the second reference current may represent currents generated according to different temperature response curves, i.e., producing different generated current curves based on the same temperatures. For instance, a current may be generated based on the two reference currents representing different temperature-dependent responses, resulting in a current that is more stable against changes in temperature.

For example, as a result of a particular temperature-dependent response designed or set for the first reference generator 111, the first reference current may increase in proportion to a positive change in temperature, while, as a result of a particular temperature-dependent response designed or set the second reference generator 112, the second reference current may increase in an inverse proportion to such a positive change in temperature, or said another way, the second reference current may decrease in proportion to such a positive change in temperature.

A driving current generator 120 may generate driving current using the first reference current and the second reference current. Accordingly, the driving current may be a current output from the current generator 100 and may have stable current characteristics against changes in temperature.

When the driving current output by the driving current generator 120 changes due to a change in temperature, the compensator 130 may attempt to compensate for that change. For instance, the compensator 130 may confirm whether the driving current and the temperature have changed. When both the temperature and the driving current have changed the compensator 130 may control the reference current generator 110 to compensate for this change to thereby adjust the driving current being generated by the driving current generator 120 to compensate for the change in temperature. As only an example, if the temperature changes but the driving current does not change, then the current setting or configuration of the reference current generator 110 and driving current generator 120 may be operating as desired, with the different first and second reference currents cooperating to generate the example stable current against the temperature change.

According to an embodiment, to compensate for a determined change in the driving current, the compensator 130 may control the reference current generator 110 to increase or decrease the amount of current of any one of the first reference current and the second reference current. For example, the compensator 130 may confirm a change in the driving current e.g., due to a change in temperature, and may control the reference current generator 110 to increase or decrease the generated amount of current of any one of the first reference current and the second reference current, thereby compensating for the confirmed change in the driving current. For example, in an embodiment, there may be a desired predetermined driving current level or corresponding representative threshold voltage level(s), and if the generated driving current diverges from this desired predetermined driving current level, e.g., by a predetermined amount, the reference current generator 110 may be controlled to adjust the respective generated current levels of the first and/or second reference currents so that the resultant driving current returns to the desired predetermined driving current level.

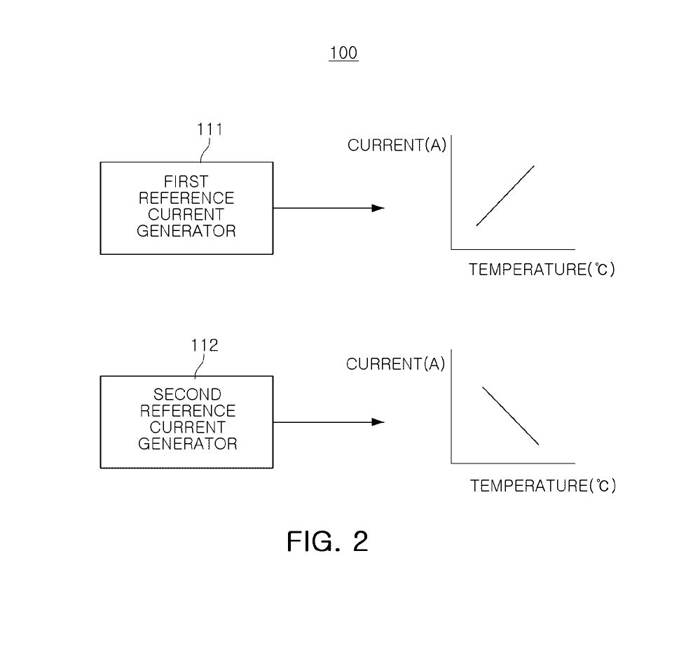

FIG. 2 is a diagram illustrating temperature characteristics of current output from a reference current generator, according to one or more embodiments. Though FIG. 2 may be explained with reference to the current generator 100 of FIG. 1, it is respectfully submitted that embodiments are not limited to the same, as alternative applications and embodiments are also available.

As illustrated in FIG. 2, the first reference current generator 111 may generate a first reference current having the amount of current that increases in proportion to a change in temperature, meaning that the first reference current may follow a current curve that may increase based on an increased temperature and may decrease based upon a decreased temperature.

The second reference current generator 112 may generate a second reference current that increases in inverse proportion to the change in temperature, meaning that the second reference current may follow a current curve that may decrease based on an increased temperature and may increase based upon a decreased temperature.

As shown, when the driving current is generated using both such a current source changed in proportion to a change in temperature and such a current source changed in inverse proportion to the change in temperature, the resultant generated driving current may have stable characteristics against changes in temperature.

Meanwhile, the compensator 130 may confirm whether there is a change in the driving current, e.g., due to such a change in temperature, and may control the reference current generator to increase or decrease the amount of current of any one of the first reference current generated by the first reference current generator 111 and the second reference current generated by the second reference current generator 112, thereby compensating for or reducing the change in driving current.

According to an embodiment and only as an example, when the driving current is determined or observed to increase or have increased, the compensator 130 may control the first reference current generator 111 to decrease the amount of current of the first reference current. For instance, taking into consideration the determined or observed change in the driving current in proportion to temperature, the compensator 130 may decrease the amount of current of the first reference current.

Alternatively, or additionally, when the driving current is determined or observed to increase or have increased, the compensator 130 may control the second reference current generator 112 to increase the amount of current of the second reference current.

According to an embodiment and only as an example, when the driving current is determined or observed to decrease or have decreased, the compensator 130 may control the first reference current generator 111 to increase the amount of current of the first reference current. For instance, taking into consideration the determined or observed change in the driving current in inverse proportion to temperature, the compensator 130 may increase the amount of current of the first reference current.

Alternatively, or additionally, when the driving current is determined or observed to decrease or have decreased, the compensator 130 may control the second reference current generator 112 to decrease the amount of current of the second reference current.

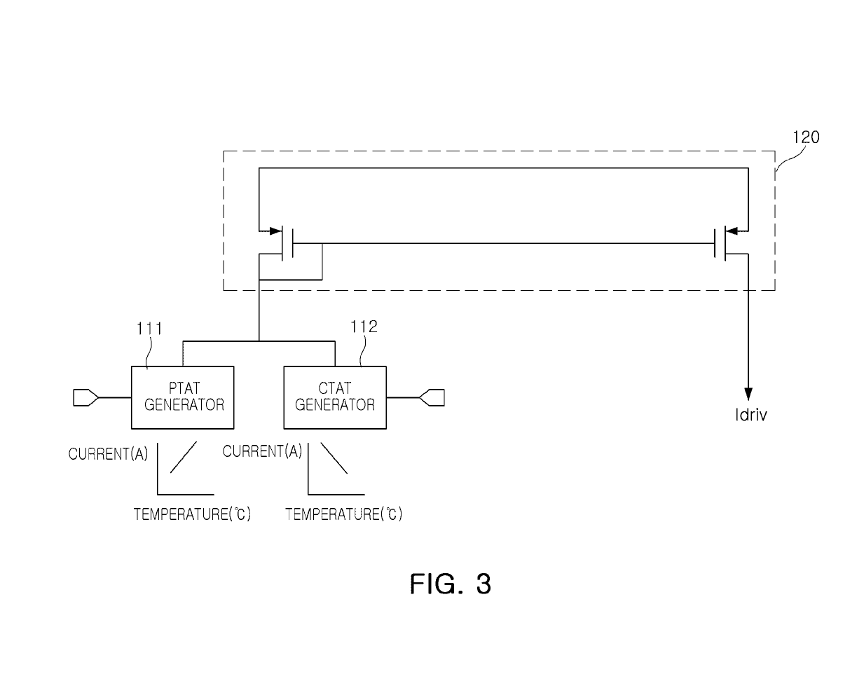

FIG. 3 is a diagram illustrating a current generator, according to one or more embodiments. Though FIG. 3 may be explained with reference to the current generator 100 of FIG. 1 and the first and second reference current generators 111,112 of FIG. 2, it is respectfully submitted that embodiments are not limited to the same, as alternative applications and embodiments are also available.

Referring to FIG. 3, the reference current generator 110 may include the first reference current generator 111 generating a first reference current that may increase and decrease in proportion to a respective increase and decrease in temperature and the second reference current generator 112 generating a second reference current that may increase and decrease in inverse proportion to a respective increase and decrease in temperature.

As only an example, FIG. 3 respectively illustrates the first reference current generator 111 as being a proportional to absolute temperature (PTAT) current source and the second reference current generator 112 as being a complementary to absolute temperature (CTAT) current source.

The driving current generator 120 may receive the first reference current and the second reference current to generate the driving current.

As illustrated, and only as an example, the driving current generator 120 may be implemented as a simple current path which respectively transfers the first reference current and the second reference current through one path to the driving current generator 120 to generate the driving current.

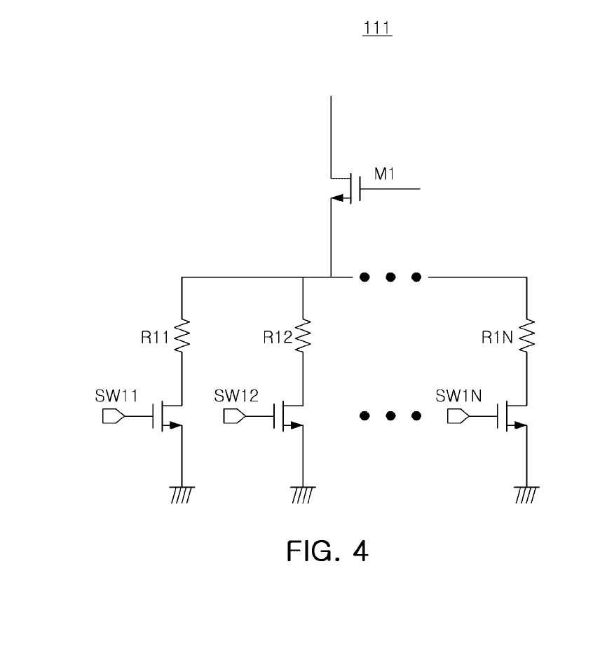

FIG. 4 is a diagram illustrating a first reference current generator, such as the first reference current generator 111 of FIG. 2, according to one or more embodiments. Though FIG. 4 may be explained with reference to the first reference current generator 111 of FIG. 2, it is respectfully submitted that embodiments are not limited to the same, as alternative applications and embodiments are also available.

Referring to FIG. 4, the first reference current generator 111 may include an output switch M1, a plurality of resistors R11 to R1N of which respective first terminals are connected to the output switch M1, and a plurality of current switches SW11 to SW1N. For each of the plurality of current switches SW11 to SW1N, a first terminal is connected to a respective second terminal of the plurality of resistors R11 to R1N and a second terminal is grounded. With the configuration of the output switch M1 and the plurality of resistor/switch arrangements, a first reference current may be generated that is proportional to temperature change.

The compensator 130 of FIG. 1, for example, may control, or initiate the control of, the switching operation of the plurality of current switches SW11 to SW1N to control the first reference current generator 111. For example, to decrease an amount of current generated by the first reference current generator 111, the compensator 130 may generate or output a control signal that controls a turning off of at least some of the turned-on switches. Alternatively, for an opposite operation of increasing the amount of current generated by the first reference current generator 111, the compensator 130 may turn on at least some of the turned off switches. Herein, as an example, an illustrated example transistor switch that is turned-on may correspond to that transistor being active or caused to become active, while the example transistor switch being turned off may correspond to that transistor being cut-off of not active or is caused to become cut-off or not active.

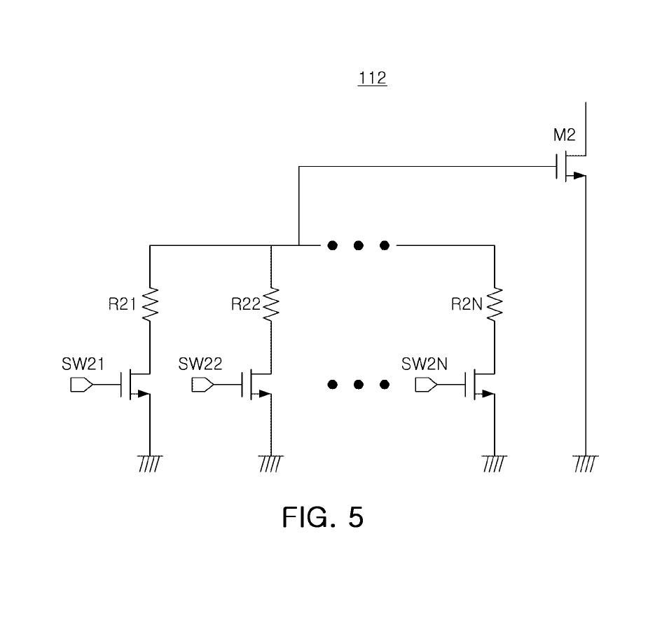

FIG. 5 is a diagram illustrating a second reference current generator, such as the second reference current generator of FIG. 1, according to one or more embodiments. Though FIG. 5 may be explained with reference to the second reference current generator 112 of FIG. 2, it is respectfully submitted that embodiments are not limited to the same, as alternative applications and embodiments are also available.

Referring to FIG. 5, the second reference current generator 112 may include an output switch M2, a plurality of resistors R21 to R2N of which respective first terminals are connected to the output switch M2, and a plurality of current switches SW21 to SW2N. For each of the plurality of current switches SW21 to SW2N, a first terminal is connected to a respective second terminal of the plurality of resistors R11 to R1N and a second terminal is grounded. With the configuration of the output switch M2 and the plurality of resistor/switch arrangements, a second reference current may be generated that is inversely proportional to temperature change.

The compensator 130 of FIG. 1, for example, may control, or initiate the control of, the switching operation of the plurality of current switches SW21 to SW2N to control the second reference current generator 112, such as discussed above with regard to FIG. 4.

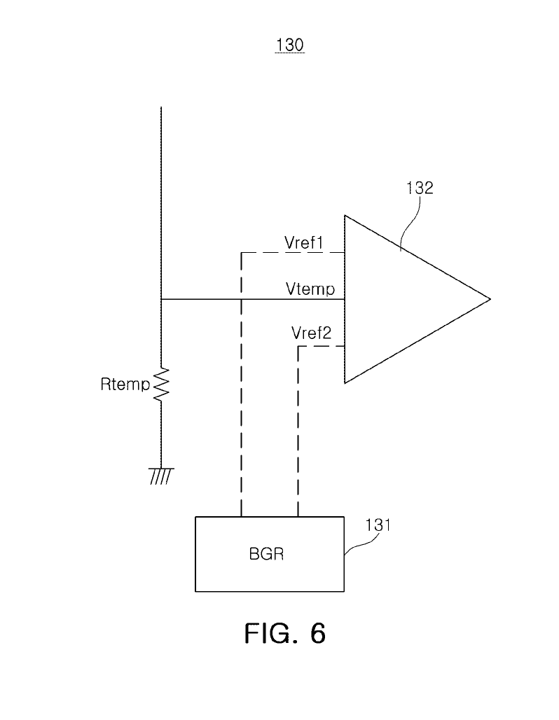

FIG. 6 is a diagram illustrating a compensator, such as the compensator 130 of FIG. 1, according to one or more embodiments. Though FIG. 6 may be explained with reference to the compensator 130 of FIG. 1, it is respectfully submitted that embodiments are not limited to the same, as alternative applications and embodiments are also available.

Referring to FIG. 6, the compensator 130 may include a voltage source 131 and a hysteresis comparator 132, for example.

The voltage source 131 may be a voltage source that is not affected or only slightly affected by changes in temperature and, thus, may provide a comparison voltage to a voltage Vₜₑₘₚ derived from the driving current. In an embodiment, and only as an example, the voltage source 131 may be a band gap reference (BGR) voltage source.

The hysteresis comparator 132 may receive the driving voltage Vₜₑₘₚ, a first comparison voltage V_{ref1}, and a second comparison voltage V_{ref2}. As noted, the driving voltage Vₜₑₘₚ may be a representative voltage corresponding to the driving current passing through the illustrated resistance Rₜₑₘₚ, and thus when the driving current changes, e.g., in proportion to a change in temperature, the driving voltage likewise changes. The first comparison voltage V_{ref1} and the second comparison voltage V_{ref2} may be different comparison voltages output from the voltage source 131. For example, when the output from the hysteresis comparator 132 increases, the driving current may be determined to be changing in proportion with an increase in temperature, and when the output from the hysteresis comparator 132 decreases when the temperature increases, the driving current may be determined to be changing in an inverse proportion with the increase in temperature. Here, such determinations based on the output of the hysteresis comparator 132 can be made because a first comparison voltage V_{ref1} may be used as a rising voltage threshold value, e.g., for use at the time when Vₜₑₘₚ is rising, and a different second comparison voltage V_{ref2} may be used as a falling voltage threshold value, e.g., for use at the time when Vₜₑₘₚ is falling, as only an example.

The hysteresis comparator 132 may output a control signal for controlling the reference current generator 110 when the driving voltage Vₜₑₘₚ meets or exceeds the first comparison voltage V_{ref1} or meets or is less than the second comparison voltage V_{ref2}.

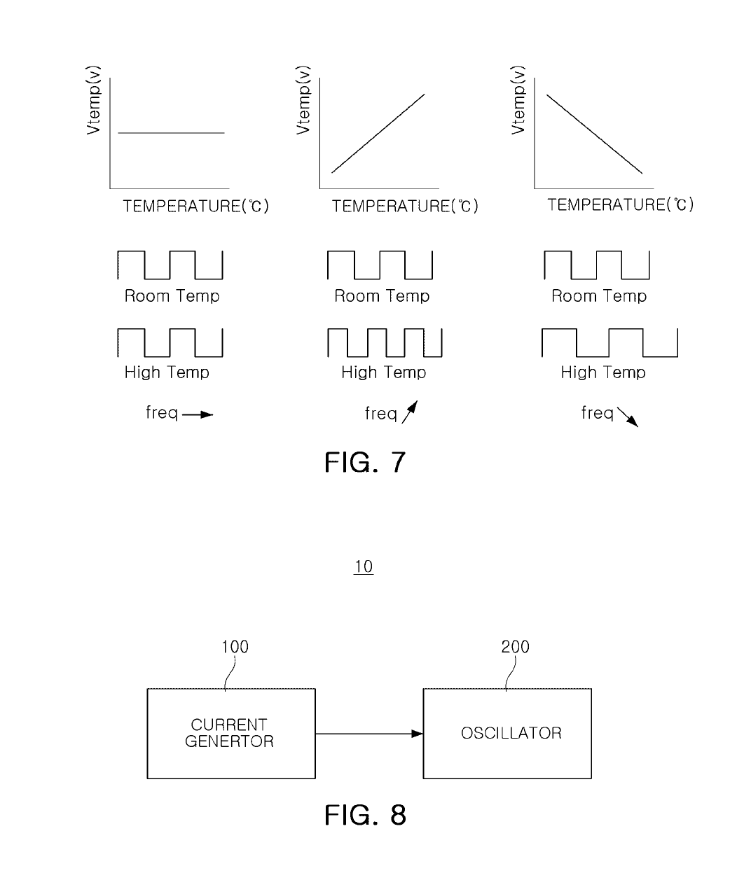

FIG. 7 is a diagram illustrating example considerations and output of a compensator, e.g., based on changes in temperature, according to one or more embodiments.

The illustrated left graphs of FIG. 7 demonstrate an example in which the resultant driving voltage Vₜₑₘₚ does not change despite a change in temperature (e.g., room temperature compared to an example higher temperature), the illustrated a center graphs of FIG. 7 demonstrate an example in which the resultant driving voltage Vₜₑₘₚ is increasing or becomes greater or increases in proportion with the example increase in temperature, and the illustrated right graphs of FIG. 7 demonstrate an example in which the illustrated driving voltage Vₜₑₘₚ is decreasing or becomes lower or decreases in proportion to the example increase in temperature, i.e., demonstrating an example in which the illustrated driving voltage Vₜₑₘₚ increases in an inverse proportion to the example increase in temperature. In the illustrated Vₜₑₘₚ graphs of FIG. 7, the horizontal axis represents increasing temperatures in Celsius (C).

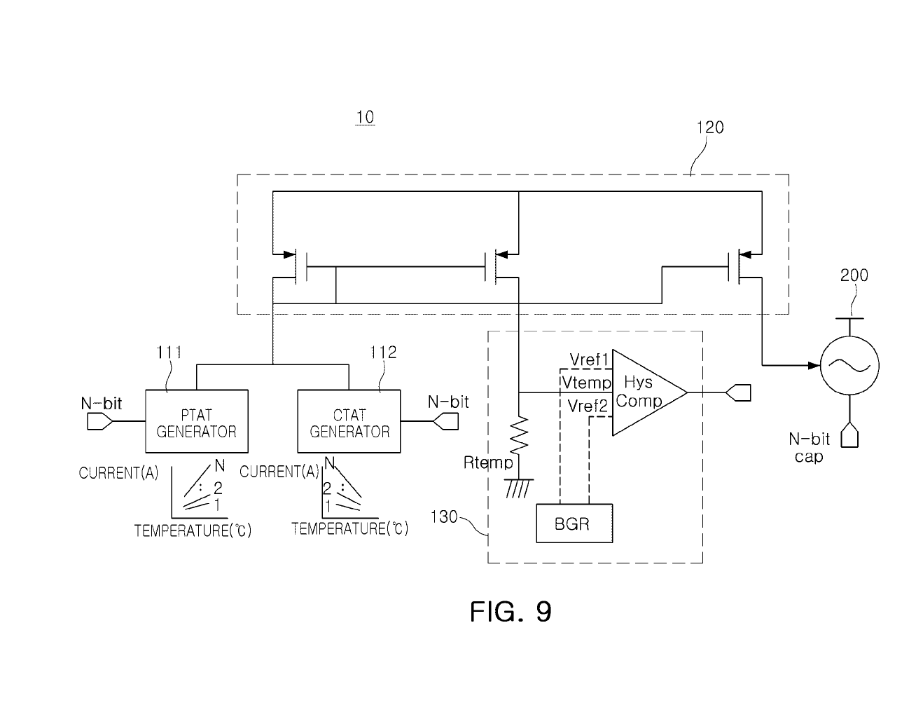

The left, center, and right graphs of FIG. 7 each also respectively illustrate resultant oscillator signal forms, such as discussed below with regard to FIGS. 8 and 9, and respective flag signals output by the comparator 130 that may control operations of the first and second reference current generators 111,112, for example. The illustrated resultant oscillator signal forms demonstrate “room” and “high” generated oscillations, e.g., based on the corresponding driving current changing similarly to the illustrated Vₜₑₘₚ graphs. The respective flag signals are demonstrated as the illustrated unchanged “freq” arrow (illustrated left), increasing “freq” arrow (illustrated center), and decreasing “freq” arrow (illustrated right). As shown in the left graphs of FIG. 7, the unchanged “freq” flag may also correspond to, or be a representation of, the frequency of the example oscillator signal not changing between the room and higher temperatures. Similarly, in the center graphs of FIG. 7, the increasing “freq” flag may also correspond to, or be a representation of, the frequency of the example oscillator signal increasing (or potentially increasing if compensation is not performed) between the room and higher temperatures, e.g., because of the increase in the corresponding driving current. Still further, in the right graphs of FIG. 7, the decreasing “freq” flag may also correspond to, or be a representation of, the frequency of the example oscillator signal decreasing (or potentially decreasing if compensation is not performed) between the room and higher temperatures, e.g., because of the decrease in the corresponding driving current. The comparator may also generate a control signal or flag to be provided to such an oscillator system of FIG. 8 or 9, for example, e.g., to calibrate components of the oscillator system such as any capacitances of the oscillator consistent with calibrations controlled of the first and second reference current generators 111,112, so as to calibrate the frequency of the oscillator to compensate for changes in temperature.

Again, as only an example, and referring to FIGS. 3 and 6, as in the left graphs of FIG. 7, when the driving voltage does not change despite a change in temperature, the hysteresis comparator 132 of FIG. 6 may not initiate a change in the driving of the reference current generator 110.

Meanwhile, as demonstrated in the center graphs of FIG. 7, when the driving voltage becomes greater or increases along with an increase in in temperature, for example, the hysteresis comparator 132 of FIG. 6 may initiate or perform an operation to cause the output from the PTAT generator 111 to be decreased and to cause the output from the CTAT generator 112 to be increased.

Further, as demonstrated in the right graphs of FIG. 7, when the driving voltage becomes lower with, or is increased in inverse proportion to, the increase in temperature, the hysteresis comparator 132 of FIG. 6 may initiate or perform an operation to cause the output from the PTAT generator 111 to be increased and to cause the output from the CTAT generator 112 to be decreased.

FIG. 8 is a diagram illustrating a clock signal generating system, according to one or more embodiments.

Referring to FIG. 8, a clock signal generating system 10 may include the current generator 100 and an oscillator 200, for example.

The current generator 100 may generate the driving current using the first reference current and the second reference current and the current generator 100 may selectively adjust at least one of the first reference current and the second reference current in response to the change in the driving current, consistent with various embodiments above described with reference to FIGS. 1 through 7, as only an example.

The oscillator 200 may generate a clock signal using the driving current output from the current generator 100. According to the embodiment, the oscillator 200 is not particularly limited. For instance, various oscillators generating the clock signal using current may be applied.

As described above, the current generator 100 may compensate for changes in the output driving current in proportion to the change in temperature, and therefore, the driving current output from the current generator 100 and the clock signal generated using the driving current may have stable characteristics against the change in temperature.

Therefore, when the clock signal is generated using the driving current, a more stable and accurate clock signal may be generated, according to one or more embodiments.

FIG. 9 is a diagram illustrating a current generator, according to one or more embodiments.

FIG. 9 shows an example of the current generator to which an N-bit control signal or flag is applied. For instance, FIG. 9 shows an example in which the CTAT generator 111, the PTAT generator 112, and a capacitor system of the oscillator 200 are each controlled by the N-bit signal or flag.

According to the example of FIG. 9, in the case of generating the driving current using the first reference current that changes in proportion to a change in temperature and the second reference current that changes in inverse proportion to the change in temperature, as only examples, respective current levels of the first reference current and/or the second reference current may be controlled/adjusted to compensate for changes in temperature. In addition, as discussed above, the capacitor system of the oscillator 200 may be similarly controlled along with, and depending on, the controlled adjusting of the respective current levels of the first reference current and/or the second reference current to secure an accurate frequency.

For example, a current level of the driving current generated by mixing an N-th reference current of the CTAT generator 111 with an N-th reference current of the PTAT generator 112 may be greater than that of a driving current generated by mixing a first reference current of the CTAT generator 111 with a first reference current of the PTAT generator 112. In an embodiment, each of the CTAT generator 111 and the PTAT generator 112 may generate, or be configured to generate, such respective first through N-th different current responses relative to changes in temperature, so a desired current level or adjustment for each of first reference current and second reference current can be used to generate the desired current level of the driving current. In an embodiment, the first through N-th different current response may be generated by the aforementioned controlling of switches SW11-SW1N of FIG. 4 or switches SW21-SW2N of FIG. 5, as only an example. In addition, to generate the same output frequency in the oscillator 200, capacitance of the oscillator 200 may be increased or decreased in concert with the compensating of the current level of the driving current. Here, the current level(s) and the capacitance may be controlled at the same ratio.

In an embodiment, the control of the capacitance of the oscillator 200 may be made by the N-bit control signal or flag. In an embodiment, the control of the capacitance of the oscillator 200 may be made using or based on the output from the hysteresis comparator 132, for example.

As set forth above, according to one or more embodiments, current and clocks signal may be stably generated even under an environment in which the temperature variably change.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is not limited by the detailed description, but further supported by the claims and their equivalents, and all variations within the scope of the claims and their equivalents are to be construed as being included in the disclosure.

What is claimed is:

1. A current generator, comprising:
a reference current generator configured to respectively generate a first reference current and a second reference current;
a driving current generator configured to generate a driving current from the first reference current and the second reference current; and
a compensator configured to respectively control the reference current generator generating of the first reference current and/or the second reference current based on a determination of whether the driving current changes.

2. The current generator of claim 1, wherein the first reference current increases in proportion to changes in temperature and the second reference current increases in inverse proportion to changes in temperature.

3. The current generator of claim 2, wherein the compensator controls the reference current generator to increase or decrease current levels of any one of the first reference current and the second reference current to compensate for a change in the driving current.

4. The current generator of claim 1, wherein the reference current generator comprises:
a first reference current generator configured to generate the first reference current so as to change in proportion to changes in temperature; and
a second reference current generator configured to generate the second reference current so as to change in inverse proportion to changes in temperature.

5. The current generator of claim 4, wherein the compensator controls the first reference current generator to decrease a current level of the first reference current when the determination indicates that the driving current is increased.

6. The current generator of claim 4, wherein the compensator controls the second reference current generator to increase a current level of the second reference current when the determination indicates that the driving current is increased.

7. The current generator of claim 4, wherein the compensator controls the first reference current generator to increase a current level of the first reference current when the determination indicates that the driving current is decreased.

8. The current generator of claim 4, wherein the compensator controls the second reference current generator to decrease a current level of the second reference current when the determination indicates that the driving current is decreased.

9. The current generator of claim 4, wherein the first reference current generator comprises:
an output switch;
a plurality of resistors having respective first terminals connected to the output switch; and
a plurality of current switches having respective first terminals that are connected to respective second terminals of the plurality of resistors, and having respective second terminals that are grounded,
wherein the compensator controls a switching operation of the plurality of current switches to control the first reference current generator.

10. The current generator of claim 1, wherein the compensator comprises a hysteresis comparator receiving a driving voltage corresponding to the driving current, a first comparison voltage, and a second comparison voltage, and the compensator outputs a control signal to the reference current generator when the driving voltage is determined to exceed the first comparison voltage or when the driving voltage is determined to be less than the second comparison voltage.

11. The current generator of claim 1, further comprising an oscillator generating a clock signal, driven by the driving current, wherein the generating of the clock signal is based on an output of the compensator corresponding to the respective control the reference current generator based on the determination of whether the driving current changes.

12. A current generator, comprising:
a current generator configured to generate a driving current from respectively generated first and second reference currents and to control the generating of the first reference current and/or the second reference current based on a determination of whether the driving current changes; and
an oscillator generating a clock signal using the driving current.

13. The current generator of claim 12, wherein the current generator comprises:
a reference current generator configured to respectively generate the first reference current and the second reference current;
a driving current generator configured to generate the driving current from the first reference current and the second reference current; and
a compensator controlling the reference current generator based on a determination of whether the driving current changes.

14. The current generator of claim 13, wherein the first reference current increases in proportion to changes in temperature,
the second reference current increases in inverse proportion to changes in temperature, and
the compensator controls the reference current generator to increase or decrease current levels of any one of the first reference current and the second reference current to compensate for a change in the driving current.

15. The current generator of claim 13, wherein the reference current generator comprises:
a first reference current generator configured to generate the first reference current so as to change in proportion to changes in temperature; and
a second reference current generator configured to generate the second reference current so as to change in inverse proportion to changes in temperature.

16. The current generator of claim 15, wherein the compensator controls the first reference current generator to decrease a current level of the first reference current when the determination indicates that the driving current is increased, or controls the second reference current generator to increase a current level of the second reference current when the determination indicates that the driving current is increased.

17. The current generator of claim 15, wherein the compensator controls the first reference current generator to increase a current level of the first reference current when the determination indicates that the driving current is decreased, or controls the second reference current generator to decrease a current level of the second reference current when the determination indicates that the driving current is decreased.

18. A current generating method, the method comprising:
generating a first reference current whose current level increases when a temperature increases;
generating a second reference current whose current level decreases when the temperature increases;
generating a driving current from the generated first reference current and the generated second reference current;
determining whether the generated driving current changes; and
controlling, based on the determining, at least one of the generating of the first reference current so as to adjust a current level of the first reference current and the generating of the second reference current so as to adjust a current level of the second reference current, to compensate for determined changes in the generated driving current.

19. The method of claim 18, further comprising generating a clock signal, driven by the driving current, wherein the generating of the clock signal includes controlling a frequency of clock signal based on the controlling of the at least one of the generating of the first reference current and the generating of the second reference current to adjust any of the current levels of the first and second reference currents.
